(19) United States
(12) Patent Application Publication
(10) Pub. No.: US 2017/0105334 A1
(43) Pub. Date: Apr. 20, 2017

(54) DEVICE FOR THE METERING OF SEED GRAIN

(71) Applicant: FARMET a.s., Ceska Skalice (CZ)

(72) Inventors: Michal Nyc, Cerveny Kostelec (CZ); Dusan Gavlas, Ceska Skalice (CZ); Marek Prislinger, Nachod (CZ)

(21) Appl. No.: 15/301,450

(22) PCT Filed: Mar. 27, 2015
(86) PCT No.: PCT/CZ2015/000028

§ 371 Date: Oct. 3, 2016

(30) Foreign Application Priority Data
Apr. 3, 2014 (CZ) PV 2014-221

(51) Int. Cl. A01C 7/04; A01C 7/20

(52) U.S. Cl. CPC A01C 7/046; A01C 7/206

(57) ABSTRACT

A device for metering of seed grain, in particular a device (19) for metering of seed grain (2) arranged on a sowing machine, comprising a carrying means (4) and a tube (3) for the outlet of seed grain (2) towards the sowing area, where the carrying means (4) is specifically made to be with negative air-pressure or positive air pressure, which comprises at least one tube (1) with pressurised air for directing seed grain (2) from the carrying means (4) into the tube (3) for the outlet of seed grain (2), and a tube (1) with pressurised air is adjacent to the carrying means (4) and its axis (5) forms a tangent (13) to the carrying means (4) an angle of β=±30°, and the tube (3) for the outlet of seed grain (2) is adjacent to the carrying means (4), wherein its axis (6) forms a tangent (13) to the carrying means (4) an angle of Y=±30°.

### TECHNICAL FIELD

The invention relates to a device for the metering of seed grain, specifically to a device for the metering of seed grain, mounted on a sowing machine, comprising a carrying means and a tube for the outlet of seed grain towards the sowing area, which is part of a machine for precise sowing.

### STATE OF THE ART

Currently, machines are known for precision sowing which comprise a metering device working as a seed grain dosing device. The metering device may be in the form of a belt, drum, disc or similar rotating geometry with a perforated surface. Seed grains become attached thanks to differences in air pressure on either side of the perforated surface. Seeds become attached to the perforations in the direction of the pressure gradient.

From prior state-of-the-art art, structural solutions solving the transporting of seeds from the metering device means towards the seed drill area are also known.

Among these structural solutions may be included a pressurised disc metering system, wherein, after being released from the metering disc, seeds typically fall by gravity into a short tube which is referred to as the seed tube and further on into the soil. A disadvantage of this design is the significant reduction in accuracy at higher seed dosing frequencies and a reduction in accuracy due to vibration of the seeding coulter moving through the soil. The gravitational system is not applicable for precision sowing of cereal grains at higher frequencies.

From patent application WO 2010059101 A1 a metering system is also known with a metering disc, which on one side of the disc positive pressure is generated which causes air to flow into the holes in the disc. The resulting pressure gradient is used to suck up seeds, which are then transported to a section of the metering disc where a device for interrupting the air flow through the holes is located. Here, the seeds are released from the metering disc and fall into seed outlet tubes which are located therein. A portion of the pressurised air escapes through the seed outlet pipe and creates an air flow that transports the seed via the tube to the soil. This partly eliminates the disadvantage of the gravitational system described above, being particularly suitable for the sowing of maize. It is not suitable for the sowing of cereal grains because, due to their low potential kinetic energy and low gained velocity, significant inaccuracies in seed spacing occur after passing through the seed outlet tube.

From another patent application, DE 102007062967 A1, a metering system with a metering disc is known, where the seeds are blown out by an air jet into the seed outlet tube in a radial direction perpendicular to the metering disc. The disadvantage of this design is a significant change in the direction of the seed after being released from the metering disc when the seed changes the direction of its movement by roughly 90°. This change in direction of movement of the seed increases at a higher revolution speed of the disc, increasing inaccuracy of seed movement in the tube and with this, great inexactitude of the final placement of seeds in the soil. A big disadvantage is also that at a certain rotational speed of the metering disc, low seed mass kinetically leads to the seeds not being directed to the seed outlet tubes but to being returned to the hopper, thereby gapping individual seeding points, which is a large fault of this sowing machine.

From the above mentioned state-of-the-art, it is obvious that the main disadvantage of known technology is that current sowing devices do not fully guarantee precision sowing, this disadvantage increases dramatically with increasing speed of movement of the metering device and of the sowing machine and with this, the associated requirements for increased speed of the sowing device.

The aim of the invention is to design a seed metering device which is able to guarantee precision sowing at higher speeds of the sowing machine through the field.

### PRINCIPLE OF THE INVENTION

The mentioned deficiencies are to a large part removed and the objectives of the invention fulfilled by a device for the metering of seed grain, specifically by a device for the metering of seed grain arranged on a sowing machine, comprising a carrying means and an outlet tube to discharge seeds towards the sowing area, where the carrying means is specifically negative or positive air pressure, which is, according to the invention, characterised by that it comprises at least one tube with pressurised air directing the grain seed from the carrying means into the seed outlet tube, while the tube with compressed air is adjacent to the carrying means and its axis forms a tangent, with the carrying means, an angle of β=±30°, and the seed outlet tube is adjacent to the carrying means, whereby its axis forms a tangent, with the carrying means, an angle of γ=±30°.

This design enables controlled movement of the grain seeds as they pass from the carrying means into the seed outlet tube, resulting in a significant increase in the precision of sowing even at high sowing speeds. To transfer the seed, a pressure drop in the opening or recess of the carrying means is used, which enables seed to be transferred from the hopper chamber to the seed outlet tubes. The use of pressurised air brings the advantage of improved movement of seed grains in the tubes.

In the most advantageous model, the axis of the tube with pressurised air is approximately parallel to the axis of the seed outlet tube. In the most advantageous model, the angle is zero degrees, which means that the tube with pressurised air and the seed outlet tube are arranged nearly tangent to the carrying means. That allows the kinetic energy of the seed being directed to the mouth of the seed outlet tube to be used and by this, to refine its movement through the tube into the sowing area. This obviously represents a further significant improvement in precision sowing.

As a variant, the axis of the tube with pressurised air may be shifted eccentrically to the seed outlet tube. This is a variant which can be advantageous in certain specific situations.

It is also to advantage if the axis of the tube with pressurised air forms an angle of Ω=0° to 30° with the plane of the carrying means, which is most advantageously a metering disc. This allows you to optimise the orientation of the seed into the mouths of the seed outlet tubes.

It is to further advantage if the axis of the seed outlet tube forms an angle of Ω=0° to 30° with the plane of the carrying means. A zero degree or very acute angle is optimal for intake of the seed grain into the tube. Seed goes directly into the tube, while not making contact with the inner surface of the tube, which means that it does not slow down nor unbalance its movement.

It is to great advantage with respect to maximum precision sowing when the mouths of the seed outlet tubes are significantly larger than the mouths of the tubes with pressurised air. This is advantageous if, for different crops, tubes with pressurised air and seed outlet tubes with various diameters are used. This improves air flow from the pressurised air tubes into the seed outlet tubes, and simultaneously improves the movement of seed grain through these tubes. That means, as stated above, that the seed grain will not slow down its movement or become unbalanced by hitting the surface of the tube at its beginning.

In an advantageous model, the carrying means is a metering disc adjacent to the chamber with openings for sucking up seeds. The holes may vary in size according to individual crops. Alternatively, the carrying means may be a negative air pressure belt.

It is to further advantage if the seed outlet tubes contain a sensor for flyby seed grains.

It is also to advantage when the seed outlet tube contains an airfoil means to direct air flow, which improves air flow through the tube and with this, the precision of movement of seed grain through the tube, and thus the precision of the sowing.

It is also advantageous when the tube with pressurised air and the seed outlet tube form a single unit.

It is also to great advantage if the carrying means contains an area without positive or negative air pressure. This area without positive or negative air pressure is created by turning off of the negative air pressure chamber or means, and covers the opening in the carrying means, and this device may be a disc pressing against the carrying means at the place where the seed grain leaves the carrying means. This design facilitates the separation of seed grain from the carrying means.

It is also to great advantage if the carrying means contains a rotatable negative air pressure chamber. This solution is preferable not only in terms of design and manufacture, but its greatest advantage is the possibility for very simple and efficient sealing, resulting in significantly lower power consumption of the entire machine and also to reduced wear on moving parts of the carrying means.

The device for metering seed grain, according to the invention allows for significant increases in precision sowing, due to the fact that the flow of highly pressurised air gives the seed grain, after its separation from the metering disc, high kinetic energy from the outset and with this, high speed. This is achieved by high flight uniformity of individual seeds through the tubes and their proper positioning at the point of exit from the tube under the pressure of the wheel coulter at the desired target of seed spacing in the sowing area, especially when there is higher frequency of grain seed moving through the sowing device, which is associated with the higher speed of movement of the sowing machine in the field.

### OVERVIEW OF THE FIGURES

The invention will be further elucidated using drawings, in which

FIG. 1 shows a partial cross sectional spatial view of the overall internal arrangement of a seed grain metering device,

FIG. 2 shows a detailed view of the spatial arrangements of a tube with pressurised air and a seed outlet tube,

FIG. 3 shows a side view of the overall arrangement of a seed grain metering device,

FIG. 4 shows a frontal view of the internal arrangement of a seed grain metering device with an indication of its function,

FIG. 5 shows a detailed view of the spatial arrangement of an eccentric tube with pressurised air and a seed outlet tube,

FIG. 6 shows a detailed view of the spatial arrangement of a seed grain metering device, which comprises a carrying means which is a negative pressure belt,

FIG. 7 shows an overall spatial arrangement of a seed grain metering device, which comprises a carrying means which is a metering belt,

FIG. 8 shows a detailed view of the spatial arrangement of a compressed air tube and a seed outlet tube, which are rotated tangentially to the carrying means,

FIG. 9 shows a cross section of the carrying means comprising a rotatable negative air pressure chamber,

FIG. 10 shows the overall spatial arrangement of the grain seed metering device, comprising a carrying means which is a metering drum,

FIG. 11 shows a cross section of the carrying means which comprises a metering disc adjacent to the negative air pressure chamber, and

FIG. 12 shows a partial side view arrangement of a device for seed grain metering on a sowing machine for precision sowing.

### EXAMPLES OF THE PERFORMANCE OF THE INVENTION

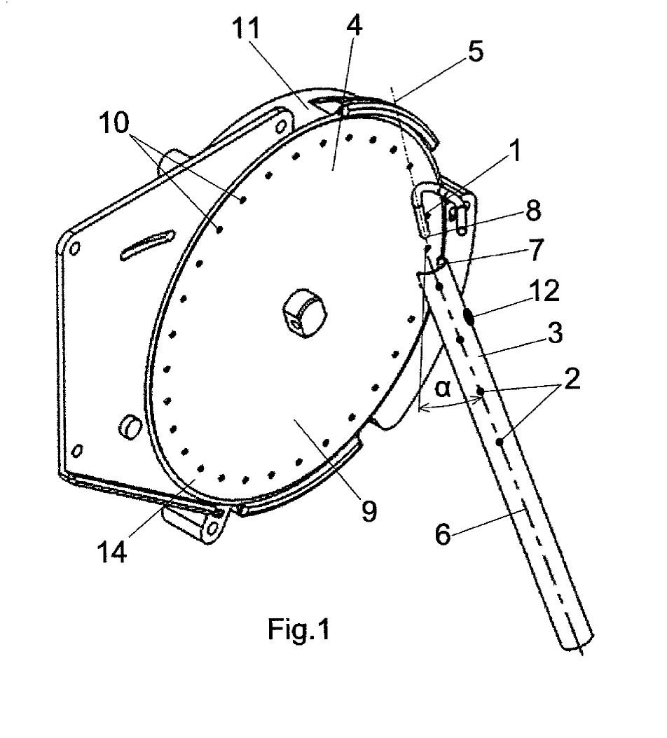

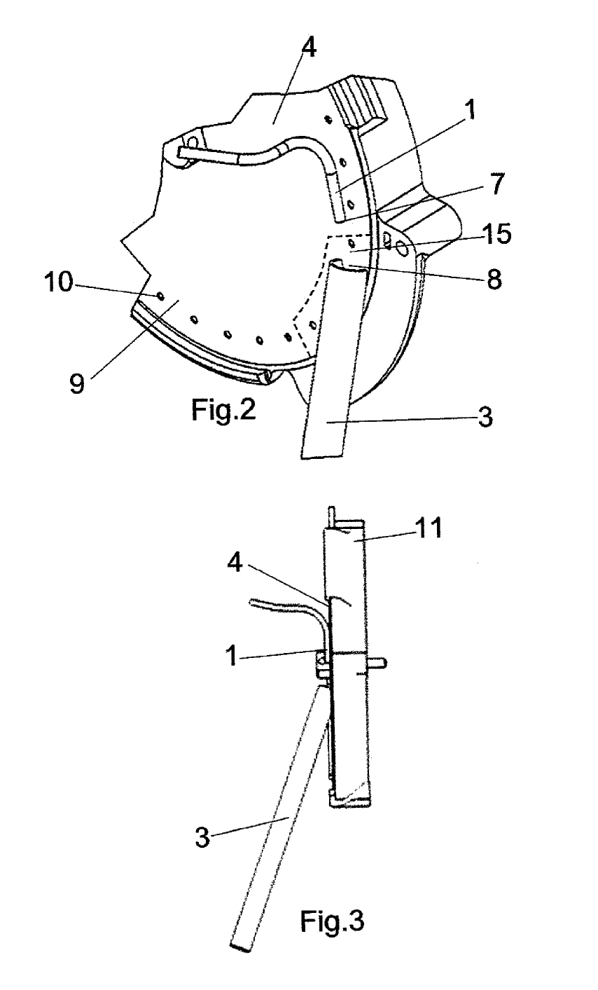

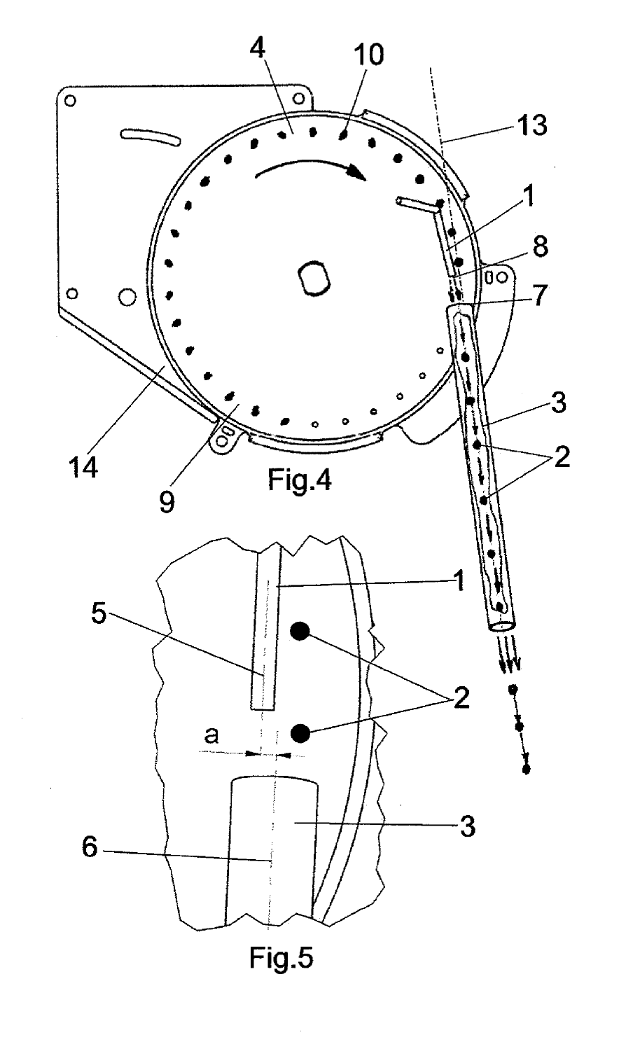

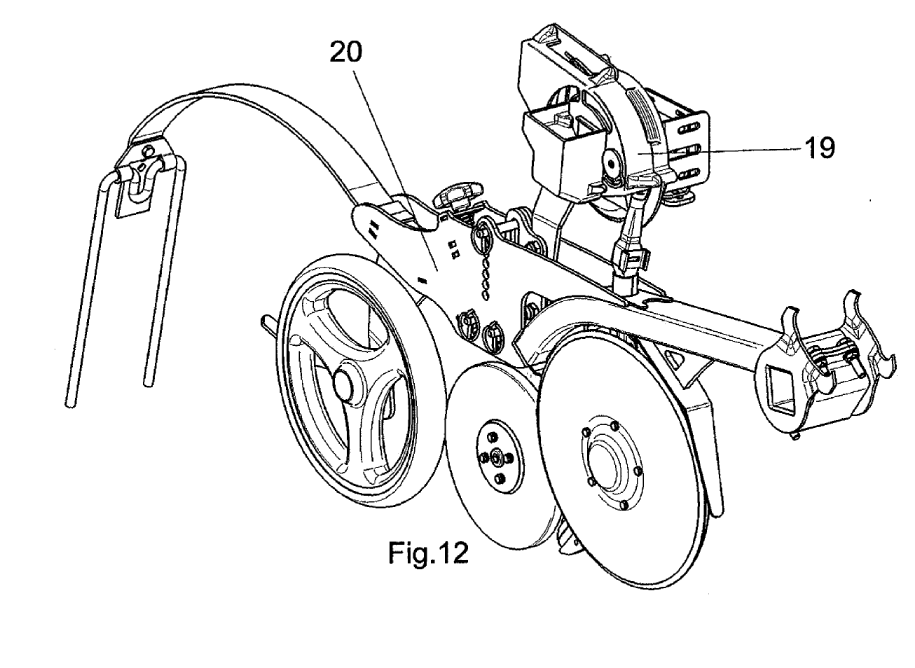

The device 19 for the metering of seed grain 2 (FIG. 1, FIG. 2, FIG. 3, FIG. 4) is arranged on a sowing machine 20 (FIG. 12) for precision sowing, which comprises a carrying means 4 and a tube 3 for the outlet of seed grain 2 towards the sowing area. The carrying means 4 is made to be with negative air pressure or positive air pressure, working on the principle of sucking up seed grain 2 using a pressurised gradient.

The carrying means 4 is a metering disc 9 (FIG. 11) with openings 10 for sucking up seed grain 2 adjacent to a negative pressure chamber 11. The openings 10 are sized with respect to the crop sown. The carrying means 4 comprises an area 15 without positive or negative air pressure, which is created by turning off the pressure chamber 11 and which is mounted (FIG. 2) approximately in the area where seed grain 2 is pulled by a stream of air from the carrying means 4 to the tube 3 for outlet of seed grain 2.

Alternatively (FIG. 9), the carrying means 4 may comprise an arranged rotatable negative pressure chamber 11.

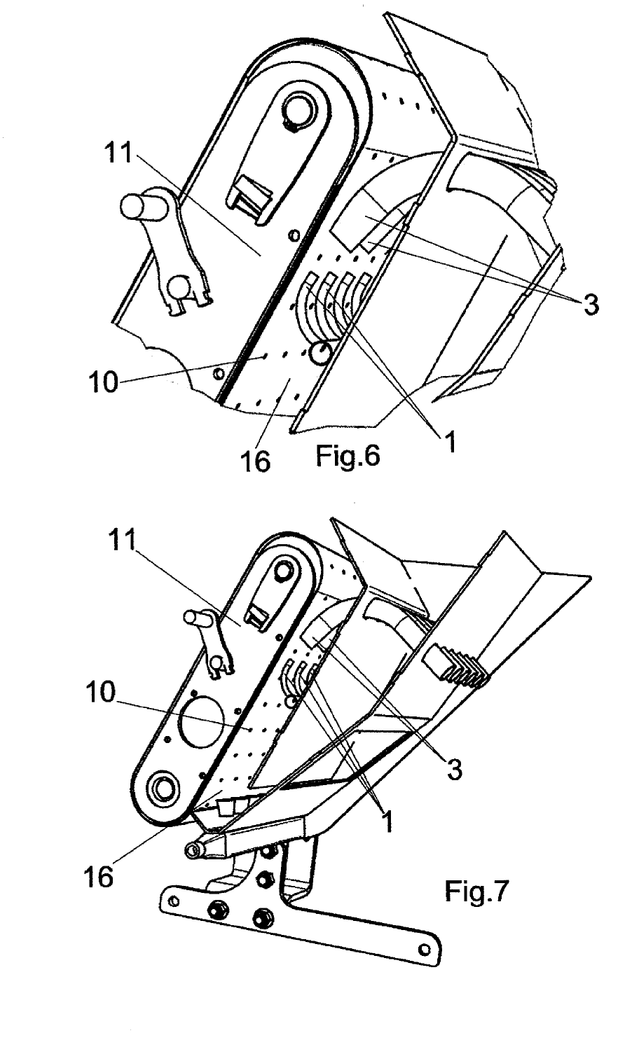

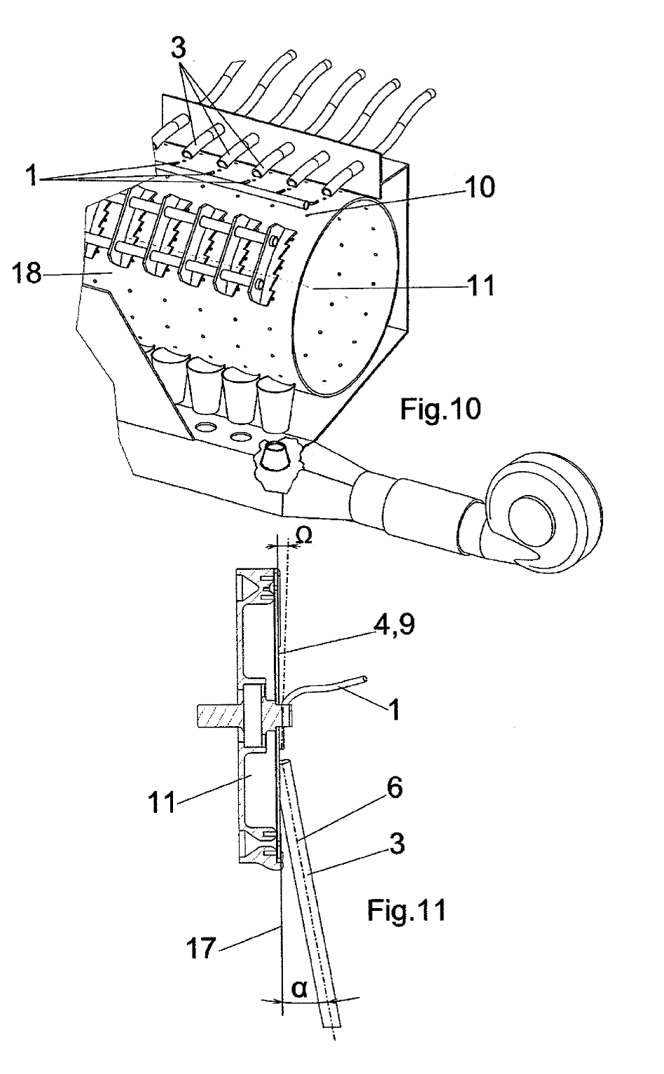

In other variations, the carrying means 4 may be a metering belt 16 (FIG. 6, FIG. 7) with openings 10 for sucking up seed grain 2 adjacent to a negative pressure chamber 11 or, a metering drum 18 (FIG. 10) with openings 10 for sucking up seed grain 2 adjacent to a negative pressure chamber 11.

The device 19 for the metering of seed grain 2 further comprising one single tube with pressurised air directing seed grain 2 from the carrying means 4 to the tube 3 for the outlet of seed grain 2.

A tube 1 with pressurised air adjacent to the carrying means 4, whose axis 5 is parallel to the tangent 13 of the carrying means 4. A tube 3 for the outlet of seed grain 2 is adjacent to the carrying means 4, which is also parallel to the tangent 13 of the carrying means 4.

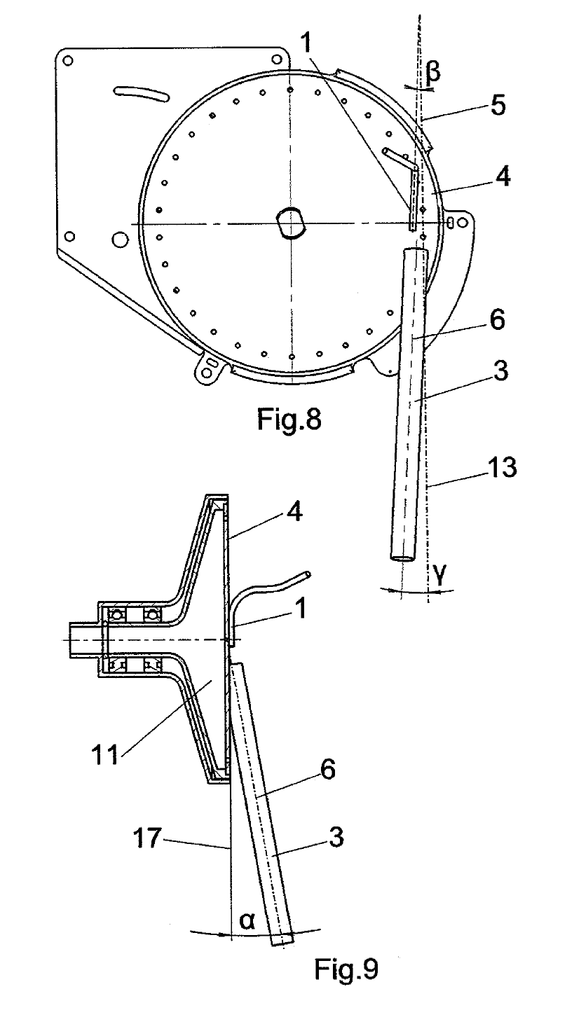

As a variant (FIG. 8), the axis 5 of a tube 1, with pressurised air tangent 13 to the carrying means 4 forms an angle of β=±30°, and the axis 6 of the tube 3 for the outlet of seed grain 2 forms with the tangent 13 of the carrying means 4 an angle of γ=±30°, and the size the angles β and γ can be different.

The axis 5 of a tube 1, with pressurised air is parallel to the axis 6 of the tube 3 for the outlet of seed grain 2.

As a variant (FIG. 5) the axis 5 of a tube 1, with pressurised air may be facing the axis 6 of the tube 3 for the outlet of seed grain 2 shifted eccentrically by a distance of “a”.

The axis 5 of a tube 1, with pressurised air is also parallel to the plane 17 of the carrying means 4, and as a variant (FIG. 11), the axis 5 of a tube 1, with pressurised air forms, with the plane 17 of the carrying means 4 an angle of ω=0° to 30°.

The axis 6 of the tube 3 for the outlet of seed grain 2 forms (FIG. 1, FIG. 9) with the plane 17 of the carrying means 4 an angle of α=15°.

The mouth 7 of the tube 3 for the outlet of seed grain 2 is significantly larger than the mouth 8 of the tube 1 with pressurised air.

The tube 3 for the outlet of seed grain 2 contains a sensor 12 for flyby seed grains 2. The tube 3 for the outlet of seed grain 2 contains an airfoil means for directing airflow—not shown.

In a variant not shown, a tube 1 with pressurised air and a tube 3 for the outlet of seed grain 2 form a single unit.

The device 19 for the metering of seed grain (FIG. 4) operates so that on one side of the carrying means 4, which is a metering disc 9, are located openings 10 with negative air pressure, and through the openings 10 of the disc 9 air flows, creating a suction effect which, on the opposite side of the metering disc 9 attaches seed grain 2. In the lower part of the filling chamber 14, where is sucked up the seed grain 2 (not shown) an air jet streaming air, which ensures fluffing of the seed grain 2, which improves sucking up of the seed grain 2. After sucking seed grain 2 onto the metering disc 9, it passes on the rotating metering disc 9 through a zone not shown—with a so-called comb, which combs off the excess seed grain 2 so that each suction opening 10 has only one grain of seed 20. On the side opposite to the filling chamber 14 is the point where seed grain 2 receives a vertical tangent trajectory, and on the back side of the metering disc 9 is located a pressure turn off—not shown. After turning off the pressure, the seed grain 2 is released, and has a tendency to continue flying on a tangent vertically downwards. In the axis tangent to this flight on the metering disc 9 is an adjacent tube 3 for the outlet of seed grain 2. Opposite the entrance to the tube 3 for the outlet of seed grain 2 is located a tube 1 with pressurised air. At the intake of seed grain 2 into the seed tube 3 is located a flyby seed sensor 12, which detects the flyby of each seed grain 2, while the electronic control system of the sowing machine, based on data about the rotating metering disc 9 and on the working speed of the sowing machine evaluates instantaneous error rates and the instantaneous actual number of dosed grains.

1. A device for the metering of seed grain arranged on a sowing machine for precision sowing, which comprises a carrying means and a tube for the outlet of seed grain towards the sowing area, where the carrying means is specifically made to be with negative air pressure or positive air pressure, wherein it comprises at least one tube with pressurised air for directing seed grain from the carrying means into the tube for the outlet of seed grain, the said tube with pressurised air is adjacent to the carrying means and its axis forms a tangent to the carrying means an angle of β=±30°, and the tube for the outlet of seed grain is adjacent to the carrying means, wherein its axis forms a tangent to the carrying means an angle of γ=±30°.

2. The device for the metering of seed grain according to claim 1, wherein the axis of the tube with pressurised air is parallel to the axis of the tube for the outlet of seed grain.

3. The device for the metering of seed grain according to claim 1, wherein the axis of the tube with pressurised air is, towards the axis of the tube for the outlet of seed grain, eccentrically shifted.

4. The device for the metering of seed grain according to claim 1, wherein the axis of the tube with pressurised air forms with the plane of the carrying means an angle of Ω=0° to 30°.

5. The device for the metering of seed grain according to claim 1, wherein the axis of the tube for the outlet of seed grain forms with the plane of the carrying means an angle of α=0° to 30°.

6. The device for the metering of seed grain according to claim 1, wherein the mouth of the tube for the outlet of seed grain is larger than the mouth of the tube with pressurised air.

7. The device for the metering of seed grain according to claim 1, wherein the tube for the outlet of seed grain comprises a sensor for flyby seed grain.

8. The device for the metering of seed grain according to claim 1, wherein the tube for the outlet of seed grain comprises an airfoil means for directing air flow.

9. The device for the metering of seed grain according to claim 1, wherein the tube with pressurised air and the tube for the outlet of seed grain form a single unit.

10. The device for the metering of seed grain according to claim 1, wherein the carrying means is a metering disc or a metering belt or a metering drum.

11. The device for the metering of seed grain according to claim 1, wherein the carrying means is a metering disc with openings or slots for sucking up seed grain adjacent to the negative pressure chamber.

12. The device for the metering of seed grain according to claim 10, wherein the carrying means comprises an arranged rotatable negative pressure chamber.

13. The device for the metering of seed grain according to claim 1, wherein the carrying means comprises an area without negative or positive air pressure.
